(19) United States
(12) Patent Application Publication
(10) Pub. No.: US 2025/0075839 A1
(43) Pub. Date: Mar. 6, 2025

(54) DEVICE FOR SEALING A LEAK IN A FLUID-TRANSPORTING PIPE AND/OR IN A FLUID RESERVOIR

(71) Applicant: 3X ENGINEERING, MONACO (MC)

(72) Inventors: Stanislas BOULET D'AURIA, VILLEFRANCHE SUR MER (FR); Didier DAUMAS, NICE (FR)

(21) Appl. No.: 18/694,269

(22) PCT Filed: Sep. 22, 2022
(86) PCT No.: PCT/EP2022/076311

§ 371 Date: Mar. 21, 2024

(30) Foreign Application Priority Data
Sep. 22, 2021 (FR) FR2109958

(51) Int. Cl. F16L 55/17

(52) U.S. Cl. CPC F16L 55/17

(57) ABSTRACT

Disclosed is a device for sealing a leak in a pipe or reservoir wall having an opening, comprising an elastomer plate applied to the wall at the site of the opening, a force applicator and a force distributor applied to the elastomer plate and means for applying a clamping torque to the force applicator. According to the main features of the invention, the force distributor has an inner face intended to be placed onto the elastomer plate, the inner face having an active zone corresponding to a protuberance and an inactive zone situated around the protuberance, in such a way that, when the clamping torque is applied to the force applicator, the active zone generates a pressure on the elastomer plate greater than the pressure generated by the inactive zone of the distributor on the elastomer plate.

### TECHNICAL FIELD

The present invention relates to the technical field of devices for repairing pipes by means of rings, strips or sleeves pressed against the outer surface of the pipe and in particular relates to a device for sealing a leak in a fluid-transporting pipe and/or in a fluid reservoir.

### BACKGROUND ART

Fluid transport pipes and, in particular, fluids under pressure, such as oil and gas, undergo deterioration in the thickness of their wall which can turn into cracks and create leaks. A technique for repairing a leaking pipe and/or reservoir consists in applying an elastomer to the location of the leak placed inside a sleeve made up of two half-shells clamped around the pipe. This sealing device has several drawbacks. On the one hand, the clamping pressure of the sleeve on the pipe must be sufficient for the elastomer to apply the pressure necessary to contain the leak. On the other hand, the half-shells being adapted to a given diameter of pipe, it is therefore necessary to provide shells having as many different diameters as there are different diameters of pipes. The two half-shell devices are not adapted to the diameter of the reservoirs which can reach several meters.

Another technique described in patent EP 1 104 532 consists in applying an elastomer plate using a force applicator and a force distributor against the crack and a clamping mechanism arranged around the pipe to apply a force on the force applicator. The force applicator transmits forces to the elastomer plate at the location of the crack, forcing the elastomer to deform so as to hug the shape of the crack and thus makes it possible to seal this crack. This device makes it possible to impose a back pressure on the elastomer-pipe interface so as to counteract the internal pressure of the fluid contained in the pipe. This back pressure is developed thanks to the mechanical tension of the clamping mechanism arranged around the pipe and around the device.

Such a sealing device has the advantage of being adaptable to many pipe diameters. However, this sealing device has several drawbacks.

On the one hand, the high and permanent pressure on the elastomer plate compresses the plate and results in shearing of the elastomer at the edge of the opening due to the pressure difference between the edge and the inside of the opening. This permanent, high-amplitude shear can damage the elastomer, leading to leakage.

On the other hand, by applying a maximum clamping torque of 40 N·m on the mechanism, the pressure obtained on the elastomer peaks at around 80 bar at 20° C. This means that, to reach a higher pressure, it is necessary to increase the clamping torque. However, beyond a clamping torque of 40 N·m, the elastomer plate deteriorates and becomes ineffective.

Furthermore, even with a maximum clamping torque of 40 N·m, the back pressure exerted at the location of the leak decreases rapidly over time and no longer sufficiently counteracts the internal pressure of the fluid, and the sealing device leaks some ten days after installation.

### SUMMARY OF INVENTION

This is why the aim of the invention is to produce a device for sealing a leak on a pipe provided with an elastomer plate and means for applying pressure to this plate which makes it possible to impose a back pressure at the elastomer-pipe interface which is sufficient to seal the leak in a lasting manner.

### Technical Solution

The object of the invention is therefore a device for sealing a leak in a pipe or reservoir wall having an opening, comprising an elastomer plate applied to the wall at the site of the opening, a force applicator and a force distributor applied to the elastomer plate and means for applying a clamping torque to the force applicator. According to the main features of the invention, the force distributor has an inner face intended to be placed onto the elastomer plate, the inner face having an active zone corresponding to a protuberance and an inactive zone situated around the protuberance, in such a way that, when the clamping torque is applied to the force applicator, the active zone generates a pressure on the elastomer plate greater than the pressure generated by the inactive zone of the distributor on the elastomer plate.

### BRIEF DESCRIPTION OF THE DRAWINGS

The purposes, objects and characteristics of the invention will be more clearly understood from the following description taken in conjunction with the accompanying drawings in which:

FIG. 1 shows a top perspective view of the applicator and force distributor according to a first embodiment of the sealing device according to the invention,

FIG. 2 shows a perspective view from below of the applicator and force distributor shown in FIG. 1,

FIG. 3 shows a cross-sectional view of the applicator and force distributor according to a second embodiment,

FIG. 4 shows a longitudinal cross-sectional view of the applicator and force distributor of the sealing device according to the invention,

FIG. 5 shows a front view of the applicator and force distributor of the sealing device according to the invention,

FIG. 6 shows a cross-sectional view of the sealing device applied to the pipe before clamping,

FIG. 7 shows a cross-sectional view of the sealing device applied to the pipe after clamping,

FIG. 8 shows the cross-sectional view of FIG. 6 with an alternative embodiment of the elastomer plate,

FIG. 9 shows the cross-sectional view of FIG. 7 with an alternative embodiment of the elastomer plate,

FIG. 10 shows a sealing device according to the invention with separate applicator and force distributor,

FIG. 11 shows a top perspective view of the applicator and force distributor according to a third embodiment of the sealing device according to the invention,

FIG. 12 shows a view from below of the applicator and force distributor shown in FIG. 11,

FIG. 13 shows the sealing device according to the third embodiment of the invention in place on the pipe,

FIG. 14 shows a cross-sectional view of the sealing device according to the third embodiment of the invention.

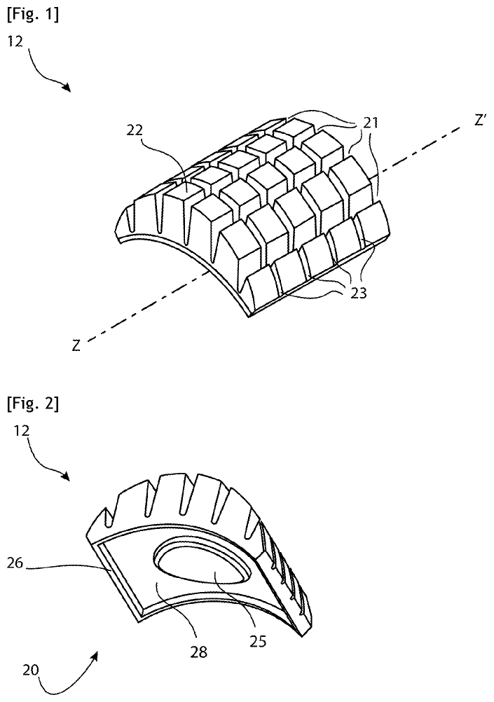

### DETAILED DESCRIPTION OF THE INVENTION

In general, the different constituent parts shown in the figures are not to scale and the sealing device according to the invention can be applied to a pipe or a reservoir but, for reasons of convenience, only the term pipe is used in the remainder of the description. The sealing device 10 according to the invention comprises a force applicator 12 intended to transmit the tension of the clamping means placed around a pipe and gripping the sealing device according to the invention. The force applicator 12 therefore converts this tension into forces. According to the invention, the clamping means is composed of at least one strap so as to form a clamping belt. The clamping belt in the form of a strap makes it possible to absorb unevenness defects in the pipe thanks to its pliability and flexibility and can adapt to large diameter pipes or reservoirs in the order of several meters (4 to 5 m in diameter, up to 10 meters in diameter).

The force applicator 12 comprises slots in two directions on its outer face. It comprises a first series of slots 23 in planes perpendicular to a ZZ′ direction, the ZZ′ axis representing the longitudinal direction of the pipe and a second series of slots 21 in directions parallel to the longitudinal ZZ′ axis. The slots define a plurality of protrusions 22 of varying thickness in the radial direction. The slots allow the force applicator to be adapted to different pipe diameters. The protrusions 22 of the force applicator 12 have a difference in thickness across the width of the applicator, the length of the latter being considered along the ZZ′ axis, and thus the force applicator has a variable thickness which is maximum in a plane of symmetry passing through the ZZ′ axis and which decreases towards the lateral edges of the applicator. Owing to the difference in thickness of the protrusions 22, the forces transmitted by the clamping belt are evenly distributed over the entire width of the applicator. This force applicator is very well suited to very small pipe diameters.

The force applicator 12 therefore transmits the tension of the clamping belt converted into force on each of the protrusions which in turn transmit these pressure forces to a distributor 20.

As can be seen in FIG. 2, the distributor 20 is located on the inner face of the force applicator 12 oriented towards the pipe and of concave or planar shape. The force applicator 12 and the distributor 20 being flexible, they can unfold or close to adapt to a wide range of pipe diameters. The distributor 20 comprises a protuberance 25 preferably of circular shape located on the inner face 28 and preferably centered thereon. The protuberance is of constant thickness and has a fillet or rounding on its edges. The material used for the force applicator 12 and 14 and the force distributor 20 is preferably a rigid but deformable plastic material such as polyamide, polypropylene or polycarbonate.

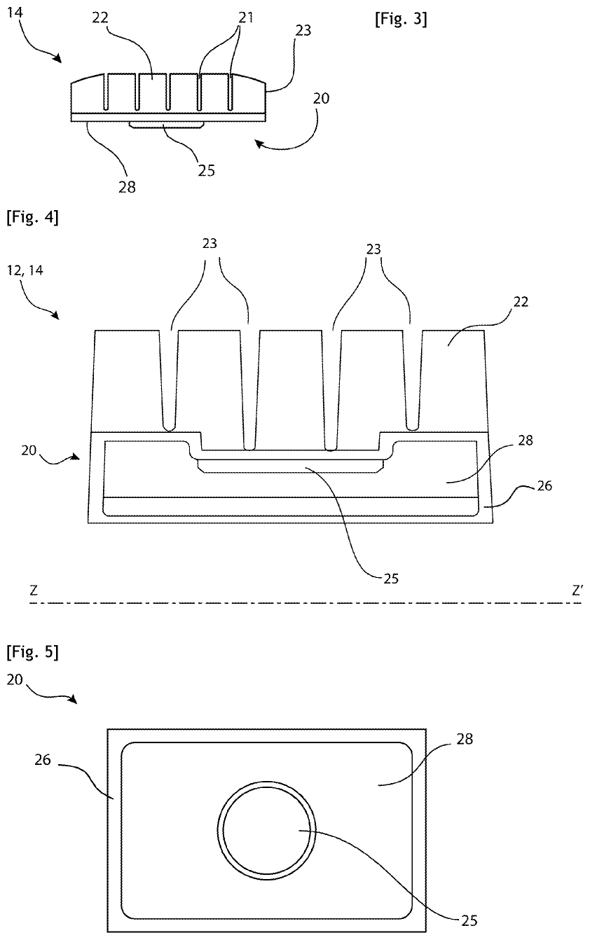

According to a second embodiment shown in cross-section in FIG. 3 along a plane perpendicular to the ZZ′ axis still representing the longitudinal direction of the pipe, the force applicator 14 comprises slots in two directions on its outer face, a first series of slots 23 in planes perpendicular to the ZZ′ axis and a second series of slots 21 in directions parallel to the longitudinal ZZ′ axis, all of the slots defining a plurality of protrusions 22. The protrusions 22 are of equal thickness except for the protrusions located on the two edges of the applicator located parallel to the longitudinal ZZ′ axis, the thickness of which decreases towards the longitudinal edges of the applicator so that edges are less sharp to limit wear of the strap making up the clamping belt.

As for the applicator 12, the applicator 14 is associated with a force distributor 20 featuring a protuberance 25 on its inner face 28. The force applicator 14 therefore transmits the tension of the clamping belt converted into force on each of the protrusions which in turn transmit these pressure forces to a distributor 20. According to the invention and whatever the embodiment, the clamping means is a part separate from the force applicator and the force distributor.

According to FIG. 4, the applicator 12 or 14 and the distributor 20 are seen in cross-section along a plane passing through the ZZ′ axis and cutting the applicator and the distributor into two equal parts. This is a longitudinal cross-section. As can be seen, the width of the slots 23 is sufficient for the protrusions 22 to move relative to one another in the case of a pipe surface having bumps due to roughness for example. The depth of the slots 23 located opposite the protuberance 25 is maximum and greater than that of the other slots. The difference in depth is between 10 and 20 percent of the maximum depth. This is clearly visible in the cross-section shown in FIG. 4. This characteristic allows constant flexibility to be obtained over the entire surface of the distributor. The inner face 28 comprises over its entire periphery a rim 26 visible in FIG. 4 only on a longitudinal edge due to the fact that the face 28 is curved, but the curvature does not constitute a limitation of the device 10 according to the invention. A front view of the distributor 20 is shown in FIG. 5.

The circular-shaped protuberance 25 is centered on the inner face 28 of the distributor. At the thickest location of the protuberance, the height of the protuberance 25 is a function of its diameter and the size of its diameter is adapted to the size of the device. More precisely, the maximum height of the protuberance 25 is equal to its squared diameter so that its stiffness is constant whatever its size. The edge of the protuberance 25 is replaced by a fillet or rounding 0.5 mm to 2 mm thick.

The inner face 28 of the distributor 20 consists of an active zone which corresponds to the surface of the protuberance 25 and an inactive zone located on the inner face 28 around the protuberance 25 and which also includes the edges 26. The surface area of the active zone represents between 25% and 40% of the surface area of the inactive zone. This greater distribution in favor of the inactive zone is due to the fact that, when the sealing device is placed on the wall of the pipe, the active zone is aligned with the opening and the inactive zone covers the entire surface corresponding to the periphery of the opening. Thanks to the applicator and the distributor, the forces transmitted by the clamping belt are evenly distributed over the entire surface of the distributor intended to be in contact with the pipe, this surface comprising the active zone and the inactive zone.

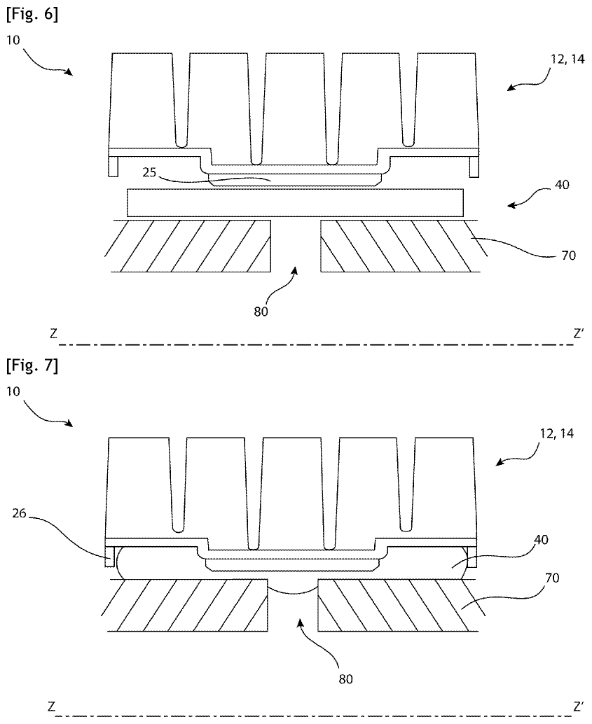

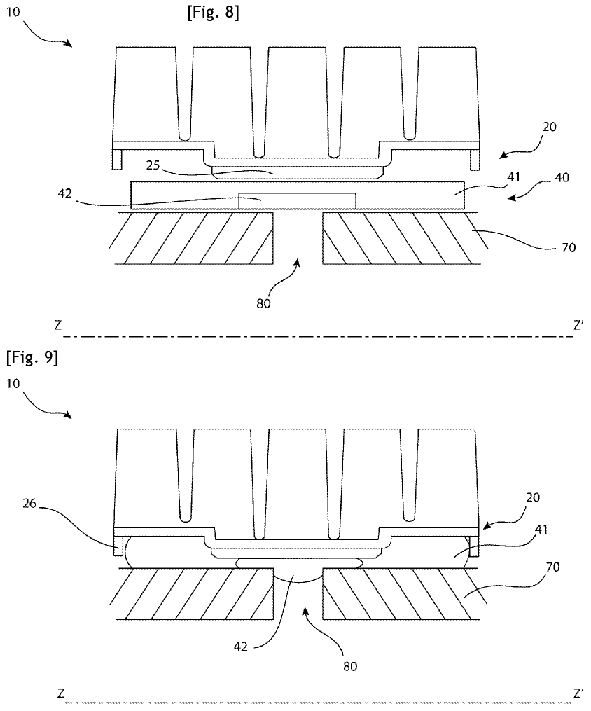

FIGS. 6 to 9 illustrate the sealing device 10 in cross-section and in place against a leak on the wall of a pipe, with the cross-sectional plane passing through ZZ′ axis. The curvature of the surface in contact with the pipe is not shown as in FIG. 4. FIGS. 6 and 8 show the sealing device 10 according to the invention in place before clamping, while FIGS. 7 and 9 show the sealing device 10 according to the invention when it is clamped in place against the pipe at the location of the leak.

In FIG. 6, an elastomer plate 40 is positioned on the wall 70 of the pipe so as to cover the opening 80 that causes the pipe contents to leak. The elastomer plate 40 comprises one or more materials. According to a first embodiment shown in FIGS. 6 and 7, the elastomer plate 40 is made up of a single, homogeneous material. The elastomer plate 40 is covered by the distributor 20 and the force applicator 12. When these three parts which make up the sealing device according to the invention are clamped against the pipe 70 at the location of the leak 80, thanks to a clamping means made up of at least one strap forming a clamping belt, the distributor multiplies the pressure exerted by the applicator by the ratio of the contact surfaces through which the forces are transmitted to the elastomer. The contact surface of the protuberance, and therefore of the active zone, being less than the application surface corresponding to the sum of the surfaces of the active zone and the inactive zone, the pressure exerted on the elastomer by the active zone is greater than the pressure exerted by the applicator.

The sealing device 10 according to the first embodiment of the invention is shown in FIG. 7 when it is clamped on the pipe by means of a clamping means not shown in the figure, such as a clamping belt including one or more straps. The clamping belt is tightened with a maximum clamping torque equal to 40 N·m. The force distributor 12 applies a clamping pressure on the elastomer plate which, owing to its elasticity, deforms and is crushed against the wall of the pipe 70. As can be partly seen in FIG. 7, the elastomer in contact with the active zone is more deformed than that located in contact with the inactive zone because it undergoes more stress. The part of the elastomer plate 40 in contact with the active zone of the distributor deforms to the point that a portion of material enters the opening 80. The entire elastomer plate 40 is subjected to pressures associated with the existing elastic crushing.

At the opening of the pipe, the elastomer is subjected to the pressure of the internal fluid and the crushing of the active zone, corresponding to the protuberance 25, of the distributor 20. At the periphery of the opening of the pipe, the elastomer undergoes crushing between the inactive zone of the distributor 20 and the wall of the pipe 70. At the opening, the elastomer undergoes greater stress and deformation than the part of the elastomer located at the periphery of the opening.

The active zone of the distributor 20, corresponding to the protuberance 25, generates a pressure on the elastomer plate greater than the pressure generated by the inactive zone of the distributor 20. The two zones of the force distributor generate a pressure distribution which imposes a significant back pressure proportional to the internal pressure level of the fluid at the leak site and a lower, but just necessary and sufficient, pressure at the periphery of the leak so as not to damage the elastomer and ensure the tightness of the sealing device according to the invention in the long term. A judicious choice of the geometries of the applicator, the distributor and the properties of the elastomers allows the device according to the invention to develop stresses capable of resisting the internal pressure of the fluid without reaching the values of stresses that could damage the elastomer. To this end, the active zone corresponding to the protuberance 25 of the distributor 20 has a constant stiffness regardless of its dimension. Depending on the material used for the force distributor, this stiffness is between 500 N/m and 5000 N/m, and, in particular, is between 1400 N/m and 1700 N/m when the force distributor is made of polyamide. The internal pressure of the fluid contained in the pipe can reach 80 bar.

According to an alternative embodiment of the invention shown in FIGS. 8 and 9, the elastomer plate 40 is made up of at least two different materials, a first material 41 which constitutes the upper part and edges of the elastomer plate 40 and a second material 42 which constitutes the central and lower part of the elastomer plate. The second material 42 is surrounded on its upper part and its lateral edges by the first material 41, the lower faces of the different materials being located in the same plane constituting the lower face of the elastomer plate 40 intended to come into contact with the wall of the pipe 70 at the location of the opening 80, the second material being intended to be pressed against the opening 80 so as to cover it. The second material is an elastomer with a hardness greater than the hardness of the elastomer making up the first material. For example, the elastomer of the first material 41 has a hardness less than 70 Shore and the elastomer of the second material 42 has a hardness greater than 70 Shore. The elastomer plate is made by overmolding the first material onto the second material or by bi-injection. The force distributor 20 is positioned on the elastomer plate 40 so that its inner face matches the radius of curvature of the pipe wall 70 and the protuberance 25 is centered on the second part 42 of the elastomer plate 40.

The sealing device 10 according to the invention is shown in FIG. 9 when it is clamped on the pipe by means of a clamping means not shown in the figure, such as a strap forming a clamping belt. The clamping belt is tightened with a maximum clamping torque equal to 40 N·m. The force distributor 20 applies a clamping pressure on the elastomer plate which, owing to its elasticity, deforms and is crushed against the wall of the pipe 70. The second material part 42 deforms to the point that a part of material enters the opening 80. At the opening, the elastomer of the second part of material 42 undergoes greater stresses and deformations than the elastomer of the first material part 41 located at the periphery of the opening.

The active zone, corresponding to the protuberance 25, generates a pressure on the elastomer plate greater than the pressure generated by the inactive zone of the distributor 20. The two zones of the force distributor generate a pressure distribution which imposes a significant back pressure proportional to the internal pressure level of the fluid at the leak site and a lower, but just necessary and sufficient, pressure at the periphery of the leak so as not to damage the elastomer and ensure the tightness of the sealing device according to the invention in the long term. For a clamping torque of 40 N·m, the pressure exerted by the sealing device according to the invention exceeds 80 bar at 20° C. owing to the protuberance 25 while it peaks at 80 bar without the protuberance. Thus, the pressure exerted is increased thanks to the piston-shaped protuberance 25 placed in the center of the elastomer plate 40 and aligned with the opening 80. During tightening, the second part 42 of the elastomer plate 40 is more deformed than the first part and undergoes significant shear stresses at the location of the edges of the opening 80. The second material 42, made of an elastomer of greater hardness, has good resistance over time and degrades less quickly than the elastomer of lower hardness of the first material. The first material 41, subjected to much less shear stress than the second material, is softer and tighter. If a tightness problem occurs at the second material 42, the first material acts as a second barrier and ensures sealing, further extending the life of the sealing device.

According to another alternative embodiment of the invention, the elastomer plate 40 comprises a third material included in the second material 42, in the same way as the second material 42 is included in the first material 41, but of smaller size. The third material is surrounded on its upper part and its lateral edges by the second material 42, the lower faces of the three materials being located in the same plane constituting the lower face of the elastomer plate 40 intended to come into contact with the wall of pipe 70 at the location of opening 80, the third material being intended to be pressed against the opening 80 so as to cover it. The third material is an elastomer with a hardness greater than the hardness of the elastomer making up the first material.

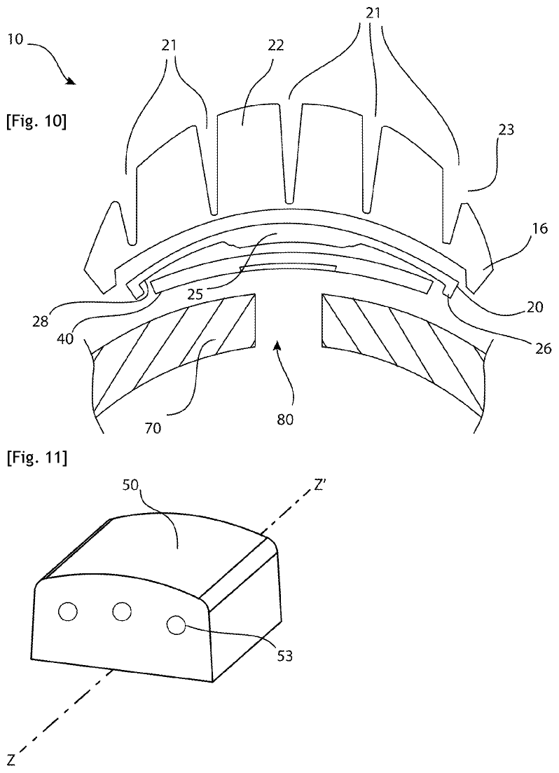

FIG. 10 represents an alternative embodiment of the sealing device in which the applicator and the force distributor are separated from each other and form two distinct parts. The sealing device according to this alternative has the same technical effects as the sealing device presented previously in which the applicator and the distributor represent a single part of the device. This alternative differs in its manufacturing process only. In FIG. 10, the view is a cross-section of the sealing device 10 along a transverse plane perpendicular to the longitudinal ZZ′ axis. The force applicator 16 comprises slots in two directions on its outer face, a first series of slots 23 in planes perpendicular to the ZZ′ axis and a second series of slots 21 in directions parallel to the longitudinal ZZ′ axis, all of the slots defining a plurality of protrusions 22. The protrusions 22 of the force applicator 16 have a difference in thickness across the width of the applicator, the length of the latter being considered along the ZZ′ axis, and thus the force applicator has a variable thickness, maximum in a plane of symmetry passing through the ZZ′ axis and which decreases towards the lateral edges of the applicator. The purpose of the force applicator 16, like the force applicators 12 and 14, is to distribute the clamping forces of the clamping belt.

The force distributor 20 is provided with a protuberance 25 on its inner face 28 and in its center. The protuberance 25 has a circular or elliptical shape and a constant thickness or has a maximum thickness in its center which decreases towards its edges. The distributor 20 is intended to be interposed between the force applicator 16 and the elastomer plate 40. The use of a force distributor separate from the applicator is suitable for use on pipes containing a low pressure fluid which does not require pressure of 80 bar on the elastomer plate. The material used for the force applicator 16 and the force distributor 20 is preferably a rigid but deformable plastic material such as polyamide, polypropylene or polycarbonate.

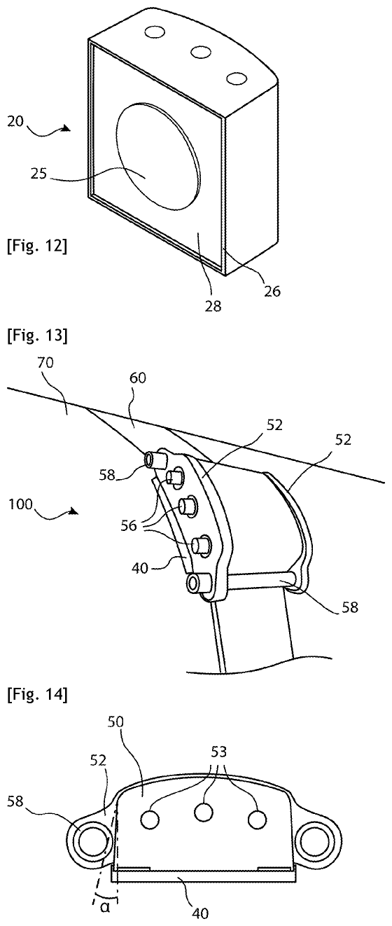

According to a third embodiment of the invention illustrated in FIGS. 11 to 14, the sealing device 100 is suitable for a pipe with a diameter greater than or equal to 1.50 m. The sealing device 100 comprises a solid force applicator 50 pierced right through along the ZZ′ axis by preferably three fixing holes 53 opening onto the transverse walls of the applicator 50. On its inner face, the force applicator 50 has a distributor 20 oriented towards the pipe. The distributor 20 comprises a protuberance 25 preferably of circular or elliptic shape located on the inner face 28 and preferably centered thereon. The protuberance has a constant thickness or has a maximum thickness in its center which decreases towards its edges.

As for the sealing device 10 of the other embodiments, the distributor 20 of the sealing device 100 consists of an active zone which corresponds to the surface of the protuberance 25 and an inactive zone located on the inner face 28 outside the protuberance 25, which also includes the edges 26. The characteristics and effects of the distributor 20 described previously for the first and second embodiments apply to the third embodiment. The alternative embodiments described above concerning the elastomer plate and the applicator and distributor which are distinct from each other are compatible with this embodiment.

In addition to the force applicator 50 and the force distributor 20, the sealing device 100 comprises a clamping belt support based on a strap 60. This strap-based clamping belt support is composed of two retaining flanges 52 and means such as assembly screws 56 to keep these retaining flanges tight against the transverse walls of the force applicator 50. The two flanges 52 are also connected by two tension bars 58 in the form of a cylinder which can rotate freely around their respective longitudinal axis. The clamping belt in the form of a strap 60 is adapted to be placed on the applicator 50 between the two flanges 52 and under the tensioning bars 58 before being clamped around the pipe 70. The free rotation of the tensioning bars 58 facilitates the positioning of the sealing device 100 on the opening before clamping.

As can be seen in FIG. 14, the tension bars 58 are distant from the longitudinal walls of the applicator so that the clamping belt in the form of a strap forms with them an alpha angle of between 10 and 20 degrees. This angle is large enough not to block the strap and small enough to reduce the friction forces of the strap on the pipe and concentrate the tightening force on the applicator 50. This also has the advantage of preventing part of the strap tightening force from being absorbed by friction forces.

The device according to the invention has the advantage of being suited to weakened pipes because it concentrates the efforts on the leak without putting unnecessary stress on the pipe.

1. A sealing device for sealing a leak in a pipe or reservoir wall having an opening, comprising an elastomer plate applied to said wall at the site of the opening, a force applicator and a force distributor applied to the elastomer plate and means for applying a clamping torque to said force applicator such as a strap forming a clamping belt,
wherein the force distributor has an inner face intended to be placed onto the elastomer plate, the inner face having an active zone corresponding to a protuberance and an inactive zone situated around said protuberance, in such a way that, when the clamping torque is applied to the force applicator, the active zone generates a pressure on the elastomer plate greater than the pressure generated by the inactive zone of the distributor on the elastomer plate.

2. The sealing device according to claim 1, wherein the force applicator comprises slots in two directions on its outer face, a first series of slots in planes perpendicular to a ZZ′ direction, the ZZ′ axis representing the longitudinal direction of the pipe, and a second series of slots in directions parallel to the longitudinal ZZ′ axis, said slots defining a plurality of protrusions.

3. The sealing device according to claim 2, wherein the protrusions of the force applicator have a difference in thickness across the width of the applicator, the length of the latter being considered along the ZZ′ axis, and thus the force applicator has a variable thickness, maximum in a plane of symmetry passing through the ZZ′ axis and which decreases towards the lateral edges of said applicator.

4. The sealing device according to claim 2, wherein the depth of the slots of the force applicator located opposite the protuberance is greater than that of the other slots.

5. The sealing device according to claim 2, wherein the protrusions of the force applicator are of equal thickness except for the protrusions located on the two edges of the applicator located parallel to the longitudinal ZZ′ axis whose thickness decreases towards the longitudinal edges of the applicator.

6. The sealing device according to claim 1, wherein the force applicator is solid and pierced right through along the ZZ′ axis by three fixing holes opening onto its transverse walls, said device comprising two retaining flanges and means such as assembly screws for retaining these holding flanges tight against the transverse walls of the force applicator, the two flanges also being connected by two tension bars in the form of a cylinder which can rotate freely around their respective longitudinal axis, the clamping belt in the form of a strap being adapted to be placed on the applicator between the two flanges and under the tensioning bars before being clamped around the pipe, the tensioning bars being distant from the longitudinal walls of the applicator so that said tightening belt in the form of a strap forms with them an alpha angle of between 10 and 20 degrees.

7. The sealing device according to claim 6, wherein the protuberance is circular and centered on the inner face of the distributor, the maximum height of said protuberance is equal to its squared diameter, so that its stiffness is constant regardless of its size.

8. The sealing device according to claim 7, wherein the protuberance of the force distributor has a stiffness of between 500 N/m and 5000 N/m.

9. The sealing device according to claim 1, wherein the elastomer plate comprises at least two materials, a first material which constitutes the upper part and edges of said plate, and a second material which constitutes the central and lower part of said plate, said second material being surrounded on its upper part and its lateral edges by said first material, said second material being an elastomer with a hardness greater than the hardness of the elastomer composing said first material, the lower faces of the different materials being located in the same plane composing the lower face of said plate intended to come into contact with the pipe wall at the location of the opening, said second material being intended to be pressed onto said opening.

10. The sealing device according to claim 9, wherein the elastomer plate comprises a third material included in the second material, said third material being surrounded on its upper part and its lateral edges by said second material, the lower faces of the three materials being located in the same plane composing the lower face of the elastomer plate intended to come into contact with the pipe wall at the location of the opening, the third material being intended to be placed on the opening so as to cover it, said third material being an elastomer with a hardness greater than the hardness of the elastomer composing said second material.

11. The sealing device according to claim 1, wherein the force applicator and the force distributor are two distinct parts.

12. The sealing device according to claim 1, wherein the material used to manufacture the force applicator and the force distributor is chosen from rigid plastic materials such as polyamide, polypropylene or polycarbonate.

13. The sealing device according to claim 12, wherein the protuberance of the force distributor made of polyamide has a stiffness of between 1400 N/m and 1700 N/m.
